(19) United States
(12) Patent Application Publication
(10) Pub. No.: US 2005/0019509 A1
(43) Pub. Date: Jan. 27, 2005

(54) Calcium ion stable emulsion polymers and uses thereof

(76) Inventors: Joseph B. Gardner, Somerset, NJ (US); Stephanie Goguen, Bridgewater, NJ (US)

Correspondence Address: NATIONAL STARCH AND CHEMICAL COMPANY, P.O. BOX 6500, BRIDGEWATER, NJ, 08807-3300, US

(21) Appl. No.: 10/464,621

(22) Filed: Jun. 17, 2003

(51) Int. Cl. F16L 1/00; B65D 1/00

(52) U.S. Cl. 428/34.1; 428/35.7; 428/492; 427/402

(57) ABSTRACT

The present invention relates to an emulsion polymer that is multi-valent ion stable. The emulsion polymer does not readily precipitate in an environment containing high levels of multi-valent ions, and in particular calcium ions. The polymer emulsion is particularly useful in the preparation of natural and synthetic rubber articles, and especially as a coating on the inner surface of a rubber glove.

The present invention relates to an emulsion polymer that is stable in a high ionic strength environment containing multi-valent cations. In particular, the polymer does not readily precipitate in an environment containing high levels of calcium ions. The polymer emulsion is particularly useful in the preparation of natural and synthetic rubber articles, and especially for use as a coating on the inner surface of a natural or synthetic rubber glove.

### BACKGROUND OF THE INVENTION

Emulsion polymers having high glass transition temperatures have been found to be useful in providing an inner coating on a natural or synthetic rubber formed article. The polymer provides good donning properties and can be coated onto the formed article, such as a glove, from an aqueous solution. The polymer can be coated onto the article by an in-line process in current manufacturing practices. The polymer coating may contain an added dispersant, as described in WO 02/22721, or the polymer may also function as the dispersant, without the need for additional dispersant, as described in U.S. patent application 10/378,026.

One problem discovered in the manufacture of polymer-coated gloves using the current polymer emulsions is that in the glove manufacturing process, calcium ions used to coagulate natural rubber onto glove formers can be transported down the manufacturing line to dipping tanks containing the emulsion polymer. As the calcium ion concentration builds, the emulsion polymer becomes destabilized, coagulates, and precipitates. This decreases the efficiency of the coating operation. Other examples of end-uses benefiting from a calcium ion stable emulsion include the building industry and paper industry where high levels of calcium carbonate are present.

U.S. Pat. No. 6,448,330 describes an emulsion polymer that is calcium stable. The polymer contains an acrylic acid ester monomer, a methacrylic acid ester monomer, a styrenic monomer, or a diene monomer, and is stabilized by poly vinyl alcohol which has been at least partially graft-bonded.

There is a need for calcium ion stable emulsions useful in the manufacture of powder-free, polymer-coated natural and synthetic gloves.

Surprisingly it has been found that the emulsion polymer of the invention does not flocculate upon exposure to a high multi-valent cationic strength environment. The emulsion polymer is especially suited for the coating of rubber articles. The primary factors believed to influence the ionic stability are the surfactant mixture, particle size, and polymer composition.

### SUMMARY OF THE INVENTION

It is an object of the invention to synthesize an emulsion polymer that is stable in a solution having a high concentration of multi-valent ions, and particularly calcium ions.

It is a further objective of the invention to synthesize a multi-valent cation-stable emulsion polymer that is useful in forming an inner coating on a natural or synthetic rubber glove.

These objectives have been met by the present invention directed to a dipping container for the polymer coating of formed natural or synthetic rubber articles comprising a container having therein an aqueous polymer formulation comprising a multivalent ion stable polymer emulsion, wherein said polymer has a Tg of from −20° C. to 120° C., wherein the average particle size of said polymer is from 100 to 400 nanometers, and wherein said polymer emulsion is stabilized with a stabilizer composition comprising a non-ionic surfactant.

The invention is further directed to a formed natural or synthetic rubber article, having deposited directly thereon a polymer formulation comprising a calcium ion stable polymer.

The invention is further directed to methods of forming a glove by dipping a former coated with a cured or uncured rubber latex into a calcium ion stable polymer formulation.

### BRIEF DESCRIPTION OF THE DRAWING

FIG. 1 is a chart summarizing the properties of the different emulsion polymers of the Examples in terms of performance as an inner glove coating, and calcium ion stability—as related to monomer composition, particle size and the type of surfactant. Table 12 found in Example 13 is helpful in explaining FIG. 1.

### DETAILED DESCRIPTION OF THE INVENTION

The present invention is to a multi-valent cation stable polymer emulsion, and its use, including in forming a coating on a substrate, and especially on a natural or synthetic rubber glove. While not being bound by any particular theory, the calcium ion stability of the emulsion is thought to be related to the polymer chemistry, the emulsion stabilization system, and the particle size of the emulsion.

By “multi-valent cation stable” and “calcium ion stable” as used herein means that a 2 percent solids polymer emulsion will show less than a 20 percent particle size growth in an environment having 1700 ppm of multi-valent cations for 24 hours. The multivalent cation concentration may be composed of calcium ions, other multi-valent ions such as magnesium, barium, and multi-valent metal ions, as well as mixtures of these.

The polymer of the invention is a hydrophobic emulsion polymer. The polymer could be a homopolymer or a copolymer. By copolymer, as used herein, is meant a polymer formed from two or more different monomers. Monomers useful in forming the copolymer include, but are not limited to (meth)acrylic copolymers, vinyl acrylics, polyvinyl acetate, vinyl copolymers, ethylene-vinyl acetate copolymers, styrenics, and polyurethanes. Optionally, the copolymer could also contain a low energy monomer, or adhesion promoting monomer. Preferably the copolymer contains an acrylic monomer. Especially preferred monomers include methylmethacrylate, butyl acrylate, acrylic acid, and methacrylic acid.

In one preferred embodiment the copolymer is formed from at least one acid monomer. The incorporation of acid monomers helps to increase the adhesion of the polymer to a substrate. The acid level is generally less than 20 percent, preferably less than 10 percent, and most preferably from 1 to 5 percent, by weight based on the total monomer. Acid monomers useful in the invention include, but are not limited to acrylic acid, 2-acrylamido-2-methyl propane sulfonic acid, sodium methallyl sulfonate, sodium vinyl sulfonate, sulfonated styrene, allyloxybenzene sulfonic acid, methacrylic acid, ethacrylic acid, alpha-chloro-acrylic acid, alpha-cyano acrylic acid, beta methyl-acrylic acid (crotonic acid), alpha-phenyl acrylic acid, beta-acryloxy propionic acid, sorbic acid, alpha-chloro sorbic acid, angelic acid, cinnamic acid, p-chloro cinnamic acid, beta-styryl acrylic acid (1-carboxy-4-phenyl butadiene-1,3), itaconic acid, maleic acid, citraconic acid, mesaconic acid, glutaconic acid, aconitic acid, fumaric acid, and tricarboxy ethylene.

The emulsion copolymer may optionally include a small amount of an olefinic monomer containing crosslinkable functionality such as alcohols, acids, silanes, siloxanes, isocyanates and epoxides. Examples of such monomers include, but not limited to, vinyltriisopropoxysilane, vinyltrimethoxysilane, vinyltriethoxysiiane, vinyl-tris(2-methoxy-ethoxy)silane and gamma-methacryloyloxypropyltrimethoxysilane.

The copolymer has a Tg −20 to 120° C., preferably from 0 to 110° C. and most preferably from 10° C. to 70° C.

In a preferred embodiment, the polymer is synthesized from at least 5 percent by weight of butyl acrylate, preferably at least 10 percent and more preferably greater than 15 percent by weight; at least 40 percent by weight of methyl methacrylate; and 1 to 5 percent by weight of methacrylic acid.

The emulsion can be formed using free radical polymerization processes. The emulsion process may be batch, continuous, or semi-continuous, may or may not be a seeded process, and may or may not utilize delayed reactor feeds. A free radical polymerization process is one in which a free-radical generator is used for initiation of the polymerization. Free radicals are generated to initiate polymerization by the use of one or more mechanisms such as photochemical initiation, thermal initiation, redox initiation, degradative initiation, ultrasonic initiation, or the like. Preferably the initiators are selected from azo-type initiators, peroxide type initiators, persulfate type initiators, or mixtures thereof. Examples of suitable peroxide initiators include, but are not limited to, diacyl peroxides, peroxy esters, peroxy ketals, di-alkyl peroxides, and hydroperoxides, specifically succinic acid peroxide, cumene hydroperoxide, t-butyl peroxy acetate, 2,2 di (t-butyl peroxy) butane, di-allyl peroxide, or mixtures thereof. Examples of suitable azo-type initiators include, but are not limited to 2,2′-azobis [2-methyl-N-(2-hydroxyethyl) propionamide], 2,2′-azobis {2-methyl-N-[2-(1-hydroxybuthyl)] propionamide), 2,2′-azobis {2-methyl-N-[1,1-bis(hydroxymethyl)-2-hydroxyethyl] propionamide, 2,2′-azobis [2-(2-imidazolin-2-yl) propane], 2,2′-azobis {2-[1-(2-hydroxyethyl)-2-imidazolin-2-yl] propane) dihydrochloride, 2,2′-azobis [2-(3,4,5,6-tetrahydropyrimidin-2-yl) propane] dihydrochloride, 2,2′-azobis [N-(2-carboxyethyl)-2-methylpropionamidine] tetrahydrate, 2,2′-azobis (2-methylpropionamide) dihydrochloride, 2,2′-azobis [2-(2-imidazolin-2-yl) propane disulfate dihydrate, 2,2′-azobis [2-(2-imidazolin-2-yl) propane] dihydrochioride, 2,2′-azobis [2-(5-methyl-2-imidazolin-2-yl) propane] dihydrochloride, 2,2′-azobis (N,N′-dimethyleneisobutyramide) dihydrochloride, 1,1′-azobis (1-cyclohexane carbonitrile), acid-functional azo-type initiators such as 4,4′-azobis (4-cyanopentanoic acid). In one embodiment the preferred initiator is a persulfate. Examples of persulfate initiators include, but are not limited to sodium persulfate, ammonium persulfate, and potassium persulfate.

In one embodiment the emulsion polymer is a star polymer. Star or radial polymers, as used herein, is intended to describe polymers that have three or more polymeric arms emanating from a central core. The star polymers have unique properties including: low viscosities in solution due to their compact structure, and high melt viscosities due to extensive entanglements relative to their linear coatings. The arms comprise homopolymers, random copolymers, or block copolymers. Further, arms within a single star structure may have the same or different composition. The star architecture of the polymer is created by the use of polyvalent mercaptan chain transfer agents. The chain transfer agent reduces the molecular weight and serves as a nucleus for a star polymer architecture. The star polymers are formed by combining polyvalent mercaptan chain transfer agents with water, surfactant, and monomer, and polymerizing them using free-radical emulsion techniques.

The polymer is made in an emulsion system, using a surfactant to form the micelles and control the particle size during the reaction, and stabilizing the polymer in the final product. The surfactant system must include at least one non-ionic surfactant to help stabilize the final polymer. Examples of suitable non-ionic surfactants include, but are not limited to alcohol ethoxylates, phenolic ethoxylates, and amino ethoxylates. Preferably the emulsion is free of any polyvinyl alcohol stabilizer. The surfactant system preferably also includes at least one anionic surfactant to help form the micelles and control the particle size of the particles. Non-limiting examples of suitable anionic surfactants are the salts of alkylsulfonates, alkylsulfinates, alkylphosphates, and alkylcarboxylates. The amount of surfactant is generally from 0.1 to 20 percent, based on the total weight of monomer.

Another key parameter of the multi-valent cation stable emulsion polymer is the particle size of the polymer. Polymers of the invention have an average particle size of between 100 and 400 nanometers, more preferably between 150 and 375 nm, and most preferably between 175 and 350 nanometers.

Emulsion polymers of the invention have unique properties. Preferably they can be diluted with water to one percent solids without flocculation. Most importantly the polymer is calcium ion stable. Multi-valent cation stability means that a 2 percent solids polymer emulsion will show less than 20 percent particle size growth when exposed to 1700 ppm of multi-valent cations for 24 hours. Preferably the emulsion polymer at 2 percent solids is stable in 10,000 ppm multi-valent cations, and even more preferably at 20,000 ppm multi-valent cations. It is preferred that the emulsion be stable (show less than 20 percent particle size growth) for a period of 5 days, and more preferably for at least 2 weeks. The property of multi-valent cation stability applies to the stability of the polymer in environments containing multi-valent ions, such as calcium, magnesium, barium, other multi-valent metal ions, and mixtures thereof.

The emulsion polymer of the present invention is useful in applications involving multivalent ion environments, and particularly calcium ions. These applications include adhesives, binders for inorganic materials, binders for paper, cement and mortar applications. A preferred application is the use of the calcium stable emulsion polymer for coating natural and synthetic rubber. The emulsion polymer may be formulated with one or more adjuvants, depending on the end-use application, to form an emulsion formulation. Useful adjuvants include, but are not limited to coupling agents, dyes, pigments, oils, fillers, thermal stabilizers, emulsifiers, surface-active agents, cross-linking agents, curing agents, wetting agents, biocides, plasticizers, anti-foaming agents, waxes, adhesion promoters, flame-retarding agents, and lubricants.

When used to coat natural or synthetic rubber, the polymer provides anti-blocking and reduces friction. By natural or synthetic rubber, as used herein, is meant materials made from low-Tg, tacky polymeric materials. Examples of such materials include, but are not limited to, butyl rubber, natural latex rubber, polyvinyl chloride, neoprene, nitrile, viton, styrene butadiene copolymers, polyurethanes, or interpenetrating polymer network emulsion polymers, or combinations of these. The rubber may be in the form of a sheet or strips, or may be formed into articles such as gloves.

In the manufacture of polymer coated gloves, or other formed articles, the gloves are formed by dipping in a series of tanks containing process materials or water. In the course of the manufacturing line, the formers are dipped into a tank containing a coagulant solution (such as calcium nitrate or calcium chloride) followed by dipping into a latex tank to coat the former with latex. The formed rubber article is subsequently coated with a polymer (which becomes the inner coating of the glove when inverted during removal from the former), to prevent blocking and improve the donning properties. During the manufacturing process, some residual calcium ions from the coagulant tank are transported down-line and mix into the polymer coating tank. Polymer that is not calcium stable will precipitate in the tank when exposed to this build-up of calcium ions. The polymers of the invention are stable in high calcium ion environments, and do not precipitate at elevated calcium ion levels.

When the emulsion polymer is used to form the inner coating on a rubber glove, it may be blended with additives useful in improving properties of the polymer coating, such as dispersants, waxes, microspheres, adhesion promoters, and rheology modifiers, surfactants, crosslinking agents, biocides, low surface energy compounds, and fillers, to form a polymer coating composition.

Dispersants are used in the polymer coating composition to promote the uniform distribution and stability of individual components. Preferably the dispersant is present at from 0.001 to 1 percent by weight, and most preferably from 0.002 to 0.2 percent by weight, based on the weight of the emulsion polymer solids. The dispersant may be a polymer, a non-polymer, or a mixture thereof. Non-polymeric dispersants useful in the present invention include, but are not limited to, anionic, cationic, nonionic, and amphoteric surfactants. Polymeric dispersants include both linear and star polymers.

The polymer coating composition may contain microspheres. Microspheres are useful in reducing the surface contact area, improving the donning, release, and anti-blocking characteristics. The microspheres have diameters below 60 microns, preferably from 1 to 40 microns, and most preferably from 5 to 30 microns. The microsphere may be made of any material that is harder than the article being coated. Examples of microspheres useful in the present invention are those made of polyamides such as nylons, polymethylmethacrylate, polystyrene, polyethylene, polypropylene, polytetrafluoroethylene, polyesters, polyethers, polysulfones, polycarbonates, polyether ether ketones, and other polymers and copolymers, silica, and microcrystalline cellulose. The microspheres preferably have a low oil adsorption of less than 150 g/100 g powder, preferably less than 100 g/100 g powder, and most preferably less than 80 g/100 g powder. If present in the polymer coating composition, the microspheres are present at from 0.005 to 10 percent by weight, and most preferably at from 0.01 to 2 percent by weight, based on the weight of the emulsion polymer solids.

A rheology modifier may be used to control the viscosity of the composition for ease of use in different manufacturing processes and equipment. Rheology modifiers useful in the present invention include, but are not limited to cellulosics such as hydroxyethylcellulose, cationic hydroxyethylcellulose, such as Polyquaternium-4 and Polyquaternium-10, hydrophobically modified hydroxyethylcellulose, carboxymethylcellulose, methylcellulose, and hydroxypropylcellulose; dispersed or soluble starches or modified starches; and polysaccharide gums such as xanthan gum, guar gum, cationic guar gum such as Guar Hydroxypropyltrimonium Chloride, and locust bean gum. Other suitable rheology modifiers include but are not limited to alkali swellable emulsion polymers, which are typically made by emulsion copolymerization of (meth)acrylic acid with compatible ethylenically unsaturated monomers such as alkyl esters of (meth)acrylic acid, hydroxyalkyl esters of (meth)acrylic acid, alpha-methyl styrene, styrene, and derivatives thereof, vinyl acetate, crotonic acid, esters of crotonic acid, and acrylamide, and derivatives thereof; hydrophobically modified alkali swellable emulsion polymers, which are alkali swellable emulsion polymers into which hydrophobic groups have been introduced; certain amphiphilic polyurethanes; poly(acrylamide), copolymers of acrylamide with compatible ethylenically unsaturated monomers, poly(vinyl amides) such as poly(vinyl pyrrolidinone); and copolymers of vinyl amides such as vinyl pyrrolidinone with compatible ethylenically unsaturated monomers. A preferred rheology modifier is a polysaccharide. The rheology modifier is typically added at from 0.001 to 10 percent by weight, and preferably from 0.002 to 2 percent by weight, based on the weight of the emulsion polymer solids.

The polymer coating composition of the present invention is made by combining each of the ingredients to form an aqueous dispersion. For example the microspheres can be dispersed in the dispersant, and that mixture added to the rest of the composition.

The polymeric coating composition may be used to coat a variety of natural and synthetic rubber items, including gloves, prophylactics, catheters, balloons, tubing, and sheeting. A particularly suitable end use application is the coating of latex gloves, including surgeons' gloves, physicians' examining gloves, and workers' gloves, more particularly powder-free latex gloves. Such coating may be used on the inside of the glove to reduce friction and promote donning.

When used to coat gloves, the polymeric coating composition may be applied using standard methods known in the art. For example, one conventional method of making latex gloves is to dip a former or mold in the shape of a hand into a coagulant mixture containing calcium nitrate. After drying, the mold is immersed in a latex emulsion for a time sufficient for the rubber to coagulate and form a coating of the desired thickness. Optionally, the glove then may be water leached to remove rubber impurities. The formed glove is then oven cured and cooled. After cooling, the glove is stripped from the mold and inverted. To coat the inside of the glove, the polymer coating composition may be applied immediately before or after latex curing.

The latex article, i.e. glove, may be formed so that the polymer coating composition coats the inside surface of the article. The polymer coating composition provides the desired glove properties without the need for chlorination or other coatings, including powders. However, if only one surface is coated, chlorination or another coating may be used to provide the desired properties on the non-coated surface.

The following examples are presented to further illustrate and explain the present invention and should not be taken as limiting in any regard.

### EXAMPLE 1

### Emulsion Radial Polymer Synthesis

A 1-liter resin kettle equipped with mechanical stirrer, condenser, nitrogen inlet, monomer inlet port, initiator inlet port, and temperature probe was charged with deionized water (190 g). The reaction was purged with nitrogen and placed under a positive nitrogen pressure for the remainder of the procedure. The reaction mixture was heated to 80° C. and the stirring was set at 300 rpm. In a separate container, a premixed solution of butyl acrylate (BA) (150 g), methyl methacrylate (MMA) (337.5 g), methacrylic acid (MAA) (12.5 g), and pentaerythritol tetrakis(3-mercaptopropionate) (PETKMP) (5.25 g) was added, with stirring, to a solution of ABEX 2010 (50 g, 30% active, anionic/non-ionic blend from Rhodia) in deionized water (190 g). An initiator solution was prepared by dissolving sodium persulfate (2.25 g) in deionized water (97.75 g). The resin kettle was charged with a portion of the monomer solution (14.8 g) and initiator solution (25 g). After 20 minutes, the remaining monomer solution was added at a constant rate over 180 minutes and, simultaneously, the remaining initiator solution was added at a constant rate over 210 minutes. After the additions were complete, the reaction mixture was held at 80° C. for an additional 60 minutes. The resulting emulsion (Polymer 1) was cooled, filtered, and neutralized to pH 7.0 using ammonium hydroxide.

### EXAMPLE 2

### Emulsion Radial Polymer Synthesis

Emulsion radial polymers were made by the process in Example 1, substituting the monomer mixtures shown in Table 1 for the monomer mixture of Example 1. For polymer 5, the surfactant concentration was increased from 1.45% to 2.90% of ABEX 2010. Laser light scattering (Brookhaven Instruments Corporation, BI-90) was used to measure particle size.

TABLE 1
Emulsion radial polymers

| | Surfactant | | Solids | MMA | BA | MAA | | Particle |
|---|---|---|---|---|---|---|---|---|
| Sample ID | Type* | % | (%) | (%) | (%) | (%) | PETKMP (%) | Size (nm) |
| Polymer 1 | ABEX | 1.45 | 50.0 | 67.5 | 30 | 2.5 | 0.50 | 212 |
| | 2010 | | | | | | | |
| Polymer 2 | ABEX | 1.45 | 49.9 | 51.5 | 47 | 1.5 | 0.50 | 280 |
| | 2010 | | | | | | | |
| Polymer 3 | ABEX | 1.45 | 51.8 | 40.0 | 60 | 0.0 | 0.50 | 230 |
| | 2010 | | | | | | | |
| Polymer 4 | ABEX | 1.45 | 49.7 | 35.0 | 60 | 5.0 | 0.50 | 229 |
| | 2010 | | | | | | | |
| Polymer 5 | ABEX | 2.90 | 51.1 | 67.5 | 30 | 2.5 | 0.50 | 180 |
| | 2010 | | | | | | | |

*ABEX 2010: anionic/non-ionic blend from Rhodia

### EXAMPLE 3

### Emulsion Radial Polymer Synthesis (Comparative)

Emulsion radial polymers were made by the process in Example 1, substituting the monomer mixtures shown in Table 2 for the monomer mixture of Example 1. These emulsion radial polymers differ from Example 1 in that the amount of butyl acrylate monomer is less than or equal to 15% of the total monomer mixture. For the present invention, the most preferred amount of butyl acrylate monomer is greater than 15% of the total monomer mixture for calcium ion resistance. Laser light scattering (Brookhaven Instruments Corporation, BI-90) was used to measure particle size.

TABLE 2
Emulsion radial polymers (butyl acrylate <15%)

| Sample | Surfactant | | Solids | MMA | BA | MAA | PETKMP | Particle Size |
|---|---|---|---|---|---|---|---|---|
| ID | Type* | % | (%) | (%) | (%) | (%) | (%) | (nm) |
| Polymer 6 | ABEX | 1.45 | 49.1 | 97.5 | 0 | 2.5 | 0.50 | 229 |
| | 2010 | | | | | | | |
| Polymer 7 | ABEX | 1.45 | 49.5 | 81.5 | 15 | 3.5 | 0.50 | 222 |
| | 2010 | | | | | | | |
| Polymer 8 | ABEX | 1.45 | 49.1 | 95.0 | 0 | 5.0 | 0.50 | 219 |
| | 2010 | | | | | | | |
| Polymer 9 | ABEX | 1.45 | 49.3 | 83.5 | 15 | 1.5 | 0.50 | 227 |
| | 2010 | | | | | | | |

*ABEX 2010: anionic/non-ionic blend from Rhodia

### EXAMPLE 4

### Emulsion Polymer Synthesis (Comparative)

Emulsion polymers were made by the process in Example 1, substituting the surfactant type and/or surfactant concentration as shown in Table 3 for the 1.45% ABEX 2010 of Example 1. These emulsion polymers differ from Example 1 in that the particle size is less than 175 nm. For the present invention, the most preferred particle size is 175 nm to 350 nm for calcium ion resistance. Polymers 12 and 13 also differ from Example 1 in that the surfactant is anionic. For the present invention, the preferred surfactant type is a blend of anionic and non-ionic moieties. Polymer 13 also differs from Example 1 in that the amount of butyl acrylate monomer is less than 15% of the total monomer mixture. For the present invention, the most preferred amount of butyl acrylate monomer is greater than 15% of the total monomer mixture for calcium ion resistance. Laser light scattering (Brookhaven Instruments Corporation, BI-90) was used to measure particle size.

TABLE 3
Emulsion polymers (particle size < 175 nm)

| | | | | | | | | | Particle |
|---|---|---|---|---|---|---|---|---|---|
| Sample | Surfactant | | Solids | MMA | BA | MAA | Styrene | PETKMP | Size |
| ID | Type* | % | (%) | (%) | (%) | (%) | (%) | (%) | (nm) |
| Polymer | Texapon | 1.30 | 50.7 | 51.5 | 47 | 1.5 | 0 | 0.50 | 137 |
| 10 | NSO | | | | | | | | |
| Polymer | Proprietary | ND | 45.0 | 67.0 | 30 | 3.0 | 0 | 0.00 | 80 |
| 11 | | | | | | | | | |
| Polymer | Steol CS | 1.11 | 52.1 | 67.5 | 30 | 2.5 | 0 | 0.50 | 169 |
| 12 | 330 | | | | | | | | |
| Polymer | SDS | 1.00 | 35.3 | 50.0 | 0 | 0.0 | 50 | 0.00 | 83 |
| 13 | | | | | | | | | |

*Texapon NSO: anionic/non-ionic blend from Cognis; Proprietary: anionic/non-ionic blend from National Starch and Chemical; Steol CS 330: anionic surfactant from Stepan; SDS: sodium dodecyl sulfate, anionic surfactant

### EXAMPLE 5

### Emulsion Polymer Synthesis (Comparative)

Emulsion polymers were made by the process of Example 1, substituting the surfactant type and/or surfactant concentration as shown in Table 4 for 1.45% ABEX 2010 of Example 1. These emulsion polymers differ from Example 1 in that the surfactant is anionic. For the present invention, the preferred surfactant type is a blend of anionic and non-ionic moieties for calcium ion resistance. Polymer 15 also differs from Example 1 in that the amount of butyl acrylate monomer is less than 15% of the total monomer mixture. For the present invention, the most preferred amount of butyl acrylate monomer is greater than 15% of the total monomer mixture for calcium ion resistance. Laser light scattering (Brookhaven Instruments Corporation, BI-90) was used to measure particle size.

TABLE 4
Emulsion polymers (anionic surfactant)

| Sample | Surfactant | | Solids | MMA | BA | MAA | | Particle Size |
|---|---|---|---|---|---|---|---|---|
| ID | Type* | % | (%) | (%) | (%) | (%) | PETKMP (%) | (nm) |
| Polymer | Steol | 0.74 | 52.1 | 67.5 | 30 | 2.5 | 0.50 | 206 |
| 14 | CS 330 | | | | | | | |
| Polymer | SDS | 1.00 | 43.6 | 90.0 | 10 | 0.0 | 0.00 | 322 |
| 15 | | | | | | | | |

*Steol CS 330: anionic surfactant from Stepan; SDS: sodium dodecyl sulfate, anionic surfactant

### EXAMPLE 6

### Emulsion Radial Polymer Synthesis (Comparative)

A 500-milliliter 4-neck round bottom flask equipped with mechanical stirrer, condenser, nitrogen inlet, monomer inlet port, initiator inlet port, and temperature probe was charged with deionized water (150 g). The reaction was purged with nitrogen and placed under a positive nitrogen pressure for the remainder of the procedure. The reaction mixture was heated to 80° C. and the stirring was set at 300 rpm. In a separate container, a premixed solution of butyl acrylate (BA) (37.5 g), methyl methacrylate (MMA) (84.38 g), methacrylic acid (MAA) (3.13 g), and pentaerythritol tetrakis(3-mercaptopropionate) (PETKMP) (1.31 g) was added, with stirring, to a solution of ABEX 2010 (25 g, 30% active, anionic/non-ionic blend from Rhodia) in deionized water (35 g). An initiator solution was prepared by dissolving sodium persulfate (1.12 g) in deionized water (50 g). The round bottom flask was charged with a portion of the monomer solution (14.8 g) and initiator solution (25 g). After 20 minutes, 30.0 g of the remaining monomer solution was added at a constant rate over 35 minutes and, simultaneously, 10.00 g of the remaining initiator solution was added at a constant rate over 45 minutes. After the additions were complete, the reaction mixture was held at 80° C. for an additional 60 minutes. The resulting emulsion (Polymer 16) was cooled and filtered. Polymer 16 differs from Example 1 in that the particle size is less than 100 nm. For the present invention, the average particle size is between 100 nm and 400 nm. Laser light scattering (Brookhaven Instruments Corporation, BI-90) was used to measure particle size.

TABLE 5
Emulsion radial polymer (particle size <100 nm)

| Sample | Surfactant | | Solids | MMA | BA | MAA | | Particle Size |
|---|---|---|---|---|---|---|---|---|
| ID | Type* | % | (%) | (%) | (%) | (%) | PETKMP (%) | (nm) |
| Polymer | ABEX | 1.94 | 13.1 | 67.5 | 30 | 2.5 | 0.50 | 85 |
| 16 | 2010 | | | | | | | |

*ABEX 2010: anionic/non-ionic blend from Rhodia

### EXAMPLE 7

### Emulsion Radial Polymer Synthesis (Comparative)

A 1-liter resin kettle equipped with mechanical stirrer, condenser, nitrogen inlet, monomer inlet port, initiator inlet port, and temperature probe was charged with deionized water (190 g). The reaction was purged with nitrogen and placed under a positive nitrogen pressure for the remainder of the procedure. The reaction mixture was heated to 80° C. and the stirring was set at 300 rpm. In a separate container, a premixed solution of butyl acrylate (BA) (150 g), methyl methacrylate (MMA) (337.5 g), methacrylic acid (MAA) (12.5 g), and pentaerythritol tetrakis(3-mercaptopropionate) (PETKMP) (5.25 g) was added, with stirring, to a solution of IGEPAL CA897 (10 g, 100% active, non-ionic surfactant from Rhodia) in deionized water (190 g). An initiator solution was prepared by dissolving sodium persulfate (2.25 g) in deionized water (97.75 g). The resin kettle was charged with a portion of the monomer solution (14.8 g) and initiator solution (25 g). After 20 minutes, 67.6 g of the remaining monomer solution was added at a constant rate over 20 minutes and, simultaneously, 17.85 g of the remaining initiator solution was added at a constant rate over 50 minutes. After the additions were complete, the reaction mixture was held at 80° C. for an additional 60 minutes. The resulting emulsion (Polymer 17) was cooled and filtered. Polymer 17 differs from Example 1 in that the surfactant type is non-ionic. For the present invention, the preferred surfactant type is a blend of anionic and non-ionic moieties for calcium ion resistance. Laser light scattering (Brookhaven Instruments Corporation, BI-90) was used to measure particle size.

TABLE 6
Emulsion Radial Polymer (non-ionic surfactant)

| Sample | Surfactant | | Solids | MMA | BA | MAA | | Particle Size |
|---|---|---|---|---|---|---|---|---|
| ID | Type* | % | (%) | (%) | (%) | (%) | PETKMP (%) | (nm) |
| Polymer | IGEPAL | 1.00 | 19.3 | 67.5 | 30 | 2.5 | 0.50 | 211 |
| 17 | CA897 | | | | | | | |

*IGEPAL CA897: non-ionic surfactant from Rhodia

### EXAMPLE 8

### Emulsion Polymer Stability in the Presence of Calcium Ions

A 1-ounce jar was charged with an emulsion polymer (10 g, 3% solids). The jar was then charged with calcium nitrate tetrahydrate (100 mg, 1,700 ppm Ca⁺⁺). Laser light scattering (Brookhaven Instruments Corporation, BI-90) was used to measure particle size (see Table 7. A calcium ion stable polymer exhibits less than 20% increase in particle size and/or no visual separation 24 hours after the addition of calcium nitrate tetrahydrate.

TABLE 7
Ionic stability test results

| | Initial | | | Particle size | Visual |
|---|---|---|---|---|---|
| Sample | particle | | Time of | at failure | separation |
| ID | size (nm) | Pass/Fail | failure | (nm) | (Y/N) |
| Polymer 1 | 212 | Pass | N/A | N/A | N |
| Polymer 2 | 280 | Pass | N/A | N/A | N |
| Polymer 3 | 230 | Pass | N/A | N/A | N |
| Polymer 4 | 229 | Pass | N/A | N/A | N |
| Polymer 5 | 180 | Pass | N/A | N/A | N |
| Polymer 6 | 229 | Fail | 1 hour | 574 | Y |
| Polymer 7 | 222 | Fail | 1 day | 291 | Y |
| Polymer 8 | 219 | Fail | 1 hour | 718 | Y |
| Polymer 9 | 227 | Fail | 1 week | 389 | Y |
| Polymer | 137 | Fail | 1 week | 171 | Y |
| 10 | | | | | |
| Polymer | 80 | Fail | 1 hour | 2067 | Y |
| 11 | | | | | |
| Polymer | 169 | Fail | 1 day | 207 | Y |
| 12 | | | | | |
| Polymer | 83 | Fail | 1 hour | 1442 | Y |
| 13 | | | | | |
| Polymer | 206 | Fail | 1 day | 460 | Y |
| 14 | | | | | |
| Polymer | 322 | Fail | 1 hour | 1263 | Y |
| 15 | | | | | |
| Polymer | 85 | Fail | 1 day | 384 | Y |
| 16 | | | | | |
| Polymer | 211 | Fail | 1 day | 1560 | Y |
| 17 | | | | | |

### EXAMPLE 9

### Emulsion Polymer Stability in the Presence of Multivalent Ions

The process in Example 8 was repeated on Polymer 1, substituting the amount and/or type of multivalent ionic salt shown in Table 8 for calcium nitrate tetrahydrate (100 mg). Laser light scattering (Brookhaven Instruments Corporation, BI-90) was used to measure particle size (see Table 8). A multivalent ion stable polymer exhibits less than 20% increase in particle size and/or no visual separation 24 hours after the addition of multivalent ionic salt.

TABLE 8
Ionic stability test results

| | Amount | Multivalent Ion | Initial PS* | | Visual separation |
|---|---|---|---|---|---|
| Multivalent salt | (mg) | (ppm) | (nm) | Pass/Fail | (Y/N) |
| Calcium nitrate | 590 | 10,000 | 212 | Pass | N |
| tetrahydrate | | | | | |
| Magnesium | 500 | 10,000 | 212 | Pass | N |
| sulfate | | | | | |
| Barium chloride | 180 | 10,000 | 212 | Pass | N |
| dihydrate | | | | | |

*PS: particle size

### EXAMPLE 10

### Preparation of Inner Surface Glove Coating Formulations

A dipping container equipped with a magnetic stirrer was charged with a premixed solution of xanthan gum (2 g), biocide (1 g), polymethyl methacrylate beads (6.25 g), and deionized water (124.08 g). The container was then charged with additional deionized water (3 kg). This mixture was allowed to stir until a uniform dispersion was obtained. The container was then charged with a premixed solution of emulsion polymer (240 g, 50% active, see Table 9) in deionized water (1 kg). The container was then charged with deionized water (626.27 g, see Table 9). The final mixture was allowed to stir until a uniform dispersion was obtained.

TABLE 9
Emulsion polymers for inner surface glove coating formulation

| | | | | Deionized |
|---|---|---|---|---|
| | | Polymer | Polymer actives | water |
| Formulation | Polymer ID | (g) | (%) | (g) |
| A | Polymer 1 | 240.0 | 50.0 | 626.27 |
| B | Polymer 2 | 240.5 | 49.9 | 625.77 |
| C | Polymer 4 | 241.4 | 49.7 | 624.87 |
| D | Polymer 11 | 266.7 | 45.0 | 599.57 |

### EXAMPLE 11

### Preparation of Natural Rubber Latex Medical Examination Gloves

A glove-dipping machine (A.C.C. Automation Company, LTS-2000) was employed to prepare medical examination gloves on textured ceramic formers. Using the available computer software (Ltsll7780), a dipping sequence was created (see Table 10). The inner surface glove coating formulations from Example 10 were utilized in step 7 of the dipping sequence.

TABLE 10
Dipping sequence

| Step | Position | Description | Time (s) | Temp (° C.) |
|---|---|---|---|---|
| 1 | Coagulant tank | Mold-release polymer, 8% | 30 | Ambient |
| | | calcium nitrate tetrahydrate | | |
| 2 | Oven | Formers in horizontal position, | 120 | 115 |
| | | with rotation | | |
| 3 | Latex tank | 30% dry rubber content | 12 | Ambient |
| 4 | Oven | Formers in horizontal position, with | 30 | 100 |
| | | rotation | | |
| 5 | Bead station | Manual beading process | N/A | N/A |
| 6 | Leach tank | Deionized water | 60 | 65 |
| 7 | Inner coating | Donning polymer | 5 | Ambient |
| | tank | | | |
| 8 | Oven | Formers in horizontal position, with | 1200 | 115 |
| | | rotation | | |
| 9 | Leach tank | Deionized water | 60 | 65 |
| 10 | Stripping station | Manual stripping process | N/A | N/A |

### EXAMPLE 12

### Glove Sample Evaluation

Medical examination gloves were prepared according to the procedure in Example 11. The donning polymer in the dipping sequence was each of the inner surface glove coating formulations prepared according to the procedure in Example 10. A grip test was employed to determine the donnability of each glove sample. With the inner surface facing each other, the glove sample is rubbed between the forefinger and thumb under moderate pressure. The coating uniformity was also monitored, looking for signs of coating delamination to indicate failure. The results are shown in Table 11.

TABLE 11
Glove evaluation results

| Sample ID | Results |
|---|---|
| Formulation A, polymer 1 | Good donnability, uniform coating, |
| | no delamination |
| Formulation B, polymer 2 | Moderate donnability, uniform coating, |
| | no delamination |
| Formulation C, polymer 4 | Poor donnability (tacky), uniform coating, |
| | no delamination |
| Formulation D, polymer 11 | Good donnability, uniform coating, |
| | no coating delamination, unstable |
| | formulation due to calcium ion sensitivity |

### Example Summary

To summarize, an emulsion polymer used to coat medical examination gloves on the inner donning surface is acceptable when two requirements are met. The first requirement is calcium ion stability; the second requirement is glove performance, especially glove donning and coating uniformity. An emulsion polymer with the proper composition, more specifically the proper choice of surfactant, proper monomer composition, and proper physical particle size, exhibits both calcium ion tolerance and good glove performance (see FIG. 1).

TABLE 12
Explanation of y-scale for summary chart in FIG. 1.

| | Particle | | | | Glove |
|---|---|---|---|---|---|
| | Size | Surfactant | Monomer | Calcium | Perfor- |
| Rating | (nm) | Type | Composition | Stability | mance |
| 0 = fail | <100 | non-ionic | ≦5% BA | ≦1 hour | Poor |
| | | or anionic | | | |
| 1 = mid-low | >120 | N/A | ≦10% BA | ≦1 day | N/A |
| 2 = mid-high | >150 | N/A | ≦15% BA | ≦1 week | N/A |
| 3 = pass | >175 | anionic/ | >15% BA | >1 week | Good |
| | | non-ionic | | | |
| | | blend | | | |

1. A dipping container for the polymer coating of formed natural or synthetic rubber articles comprising a container having therein an aqueous polymer formulation comprising a multivalent ion stable polymer emulsion, wherein said polymer has a Tg of from −20° C. to 120° C., wherein the average particle size of said polymer is from 100 to 400 nanometers, and wherein said polymer emulsion is stabilized with a stabilizer composition comprising a non-ionic surfactant.

2. The dipping container of claim 1 wherein said aqueous polymer formulation comprises from 0.1 to 10 percent by weight of said multivalent ion stable polymer.

3. The dipping container of claim 1 wherein said multivalent ion comprises calcium.

4. The dipping container of claim 1 wherein said calcium stable polymer comprises at least 5 percent by weight of butyl acrylate monomer units, at least 40 percent by weight of methylmethacrylate monomer units, and from 1 to 5 percent by weight of methacrylic acid monomer units.

5. The dipping container of claim 1 wherein said calcium stable polymer comprises acid monomer units.

6. The dipping container of claim 1 wherein said calcium stable polymer has a Tg of from 0 to 110° C.

7. The dipping container of claim 1 wherein said stabilizer consists of a blend of one or more anionic surfactants and one or more non-ionic surfactants.

8. The dipping container of claim 7 wherein said stabilizer does not comprise polyvinyl alcohol.

9. The dipping container of claim 1 wherein the average particle size of said calcium stable polymer is from 150 to 375 nanometers.

10. The dipping container of claim 1 wherein the average particle size of said calcium stable polymer is from 175 to 350 nanometers.

11. The dipping container of claim 1 wherein said aqueous polymer formulation further comprises one or more additives selected from the group consisting of from 0.001 to 10 percent by weight of a rheology modifier, from 0.005 to 10 percent by weight of microspheres, and from 0.001 to 1 percent by weight of dispersant; all weight percentages based on the weight of the emulsion polymer solids.

12. A formed natural or synthetic rubber article, having deposited directly thereon a polymer formulation comprising a calcium ion stable polymer emulsion, wherein said polymer has a Tg of from −20° C. to 120° C., wherein the average particle size of said polymer is from 100 to 400 nanometers, and wherein said polymer emulsion is stabilized with a stabilizer composition comprising a non-ionic surfactant.

14. A method of making a glove comprising:
a) dipping a former into a liquid comprising a coagulant, removing the former from the coagulant and drying it to form a layer of coagulant on the former;
b) dipping the former into rubber latex and drying it to form a partially-cured rubber deposit on the former;
c) dipping the deposit of rubber into a dispersion comprising a calcium ion stable polymer, and drying it to form a polymer coating on the rubber deposit;
d) vulcanizing the deposit of rubber with the polymer coating in an oven at about 100° C. until the rubber is vulcanized to the desired degree and the layers are bonded to the rubber; and
a) cooling and then removing a finished glove from the said former.

15. The method of claim 14, further comprising after step (b) and before step (c), dipping the partially cured rubber deposit into water for sufficient time to remove at least some soluble proteins and other contaminants from the partially cured rubber deposit to form a leached partially cured rubber deposit.

16. A method of making a glove comprising:
a) dipping a former into a liquid comprising a coagulant, removing the former from the coagulant and drying it to form a layer of coagulant on the former;
b) dipping the former into rubber latex and drying it to form a partially-cured rubber deposit on the former;
c) vulcanizing the deposit in an oven at about 100° C. until the rubber is vulcanized to the desired degree and the layers are bonded to the rubber;
d) dipping the deposit of rubber into a dispersion comprising a calcium ion stable polymer, and drying it to form a polymer coating on the rubber deposit; and
b) cooling and then removing a finished glove from the said former.

17. The method of claim 16, further comprising after step (b) and before step (c), dipping the partially cured rubber deposit into water for sufficient time to remove at least some soluble proteins and other contaminants from the partially cured rubber deposit to form a leached partially cured rubber deposit.
